(19) United States
(12) Patent Application Publication
(10) Pub. No.: US 2007/0140277 A1
(43) Pub. Date: Jun. 21, 2007

(54) Packet transmission apparatus and processing method for the same

(75) Inventors: Wei-Pin Chen, Taipei (TW); Yun-Fei Chao, Taipei (TW); Li-Hsiang Wang, Taipei (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: VIA Technologies Inc.

(21) Appl. No.: 11/313,609

(22) Filed: Dec. 20, 2005

(51) Int. Cl. H04L 12/28

(52) U.S. Cl. 370/404

(57) ABSTRACT

A packet transmission method. A switch, a server, and at least one host are provided. The switch comprises at least one first port and one second port and the host connects to the switch via the first port and the server connects to the switch via the second port. The server transmits a frame with a VID value to the host via the second port. It is determined whether the first port and the second port are the same group members. If so, the frame is forwarded to the first port. It is then determined whether the VID value of the frame is acceptable by the first port. If unacceptable, the VID value of the frame is swapped with an acceptable VID value, and the host receiving the frame with the swapped VID value via the first port.

### BACKGROUND OF THE INVENTION

1. Field of the Invention

The invention relates to a packet transmission method, and more particularly, to a packet transmission method applied in a virtual local area network (VLAN).

2. Description of the Related Art

A VLAN is a switched network that is logically segmented on an organizational basis, by function, project teams, or applications, rather than on a physical or geographical basis. For example, all entities used by a particular workgroup team can be connected to the same VLAN, regardless of their physical connections to the network or the fact that they might be intermingled with other teams. Reconfiguration of the network can be performed through software rather than by physically unplugging and moving devices or wires. Floy E. Ross discloses an arrangement that is capable of associating any port of a switch with any particular segregated network group in U.S. Pat. No. 5,394,402, issued on Feb. 28, 1995. According to this patent, any number of physical ports may be associated with any number of groups within the switch by using a VLAN arrangement that virtually associates the port with a particular VLAN designation. Additionally, VLAN switching is accomplished through frame tagging where traffic originating and contained within a particular virtual topology carries a unique VLAN identifier (VID) as it traverses a common backbone or trunk link. The VID allows VLAN switches and routers to selectively forward messages to ports with the same VID in aspect of port-based, address-based, or protocol-based VLAN mechanism. The VID is the identification of the VLAN, which is used by the standard 802.1Q (or 802.1v for protocol-based) and, being 12 bit, allows for the identification of 4096 VLANs. Additionally, ports of a switch are grouped as multiple VLAN member ports, in which a port can only transmit frames to another port defined in the same member group.

FIG. 1 is schematic view of a traditional switch.

Switch 100 comprises ports 1, 2, and 3 (P1, P2, and P3). Host A connects to switch 100 via P1, host B connects to switch 100 via P2, and server 150 connects to switch 100 via P3. Ports P1 and P3 are grouped as VLAN 1 members for switch 100, ports P2 and P3 are grouped as VLAN 2 members for switch 100, and ports P1, P2, and P3 are grouped as VLAN 3 members for switch 100. Based on network restriction for P1 and P2, host A can only transmit and accept VLAN-tagged frames with VID=1 via P1 and host B can only transmit and accept VLAN-tagged frames with VID=2 via P2, while P3 is not the only VLAN-tagged frame port that server 200 can transmit and accept any VLAN-tagged frame via P3.

According to Institute of Electrical and Electronic Engineers (IEEE) 802.1Q VLAN standards, host A transmits a VLAN-tagged frame with VID=1 to server via P1. A lookup operation is executed to determine P1 and P3 are the same VLAN members, such that the VLAN-tagged frame with VID=1 is forwarded to P3 and server 150 receives the frame. Next, server 150 transmits a VLAN-tagged frame with VID=3 to host A via P3. A lookup operation is executed to determine P1 and P3 are the same VLAN members, such that the VLAN-tagged frame with VID=3 is forwarded to P1. To prevent host from transmitting VLAN-tagged frame with VID=3 to other hosts, host A is restricted to only transmit and accept VLAN-tagged frames with VID=1, and therefore host A cannot accept the VLAN-tagged frame with VID=3 from server 150 via P1, resulting in incomplete frame transmission.

Thus, the invention provides a packet transmission method applied in a virtual local area network, enabling a host to receive VLAN-tagged frames with different VIDs via a restricted port of a switch.

### BRIEF SUMMARY OF THE INVENTION

A packet transmission apparatus applied in a VLAN is provided. An embodiment of such a system comprises a switch, a server, and a host. The switch comprises a first port, a second port, selector coupling to the first port, a swap unit, a control processor, and a memory. The memory stores a VID member contrast table. The server, connecting to the switch via the second port, transmits a frame with a VID value via the second port. The host, connecting to the switch via the first port, receives the frame from the server. The control processor determines whether the first port and the second port are the same group members according to the VID member contrast table. If so, the swap unit forwards the frame to the selector. The selector determines whether the VID value of the frame is acceptable and, if not, swaps the VID value of the frame with an acceptable VID value. The host receives the frame with the swapped VID value via the first port.

A packet transmission method applied in a VLAN is provided. In an embodiment of such a method, a switch, a server, and at least one host are provided. The switch comprises at least one first port and one second port and the host connects to the switch via the first port and the server connects to the switch via the second port. The server transmits a frame with a VID value to the host via the second port. It is determined whether the first port and the second port are the same group members. If so, the frame is forwarded to the first port. It is then determined whether the VID value of the frame is acceptable by the first port. If unacceptable, the VID value of the frame is swapped with an acceptable VID value, and the host receives the frame with the swapped VID value via the first port.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is schematic view of a traditional switch.

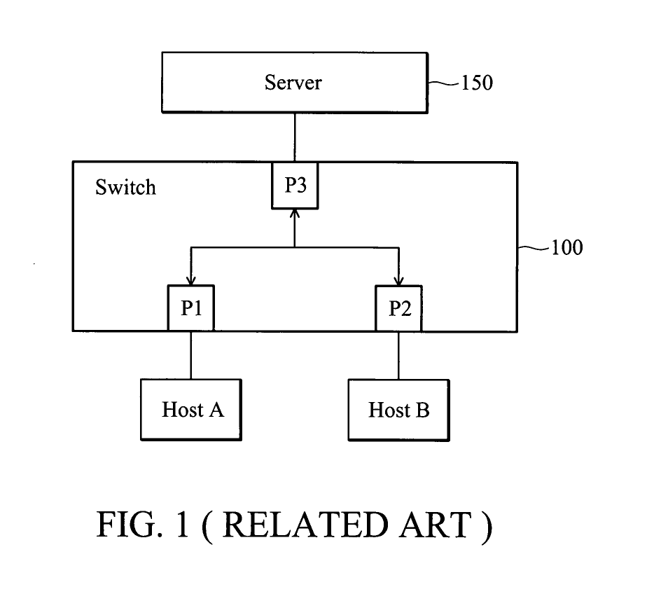

FIG. 2 is a schematic view of an embodiment of a packet transmission apparatus;

FIG. 3 is a schematic view of the architecture of switch 200 shown in FIG. 2;

FIG. 4 is a schematic view of an embodiment of the architecture of selector 216a shown in FIG. 3;

FIG. 5 is a schematic view of another embodiment of the architecture of selector 216a shown in FIG. 3;

FIG. 6 is a flowchart of an embodiment of a packet transmission method applied in a VLAN; and

FIG. 7 is a schematic view of the architecture of a VLAN-tagged frame, in which a frame transformed with a swap VID is showed.

### DETAILED DESCRIPTION OF THE INVENTION

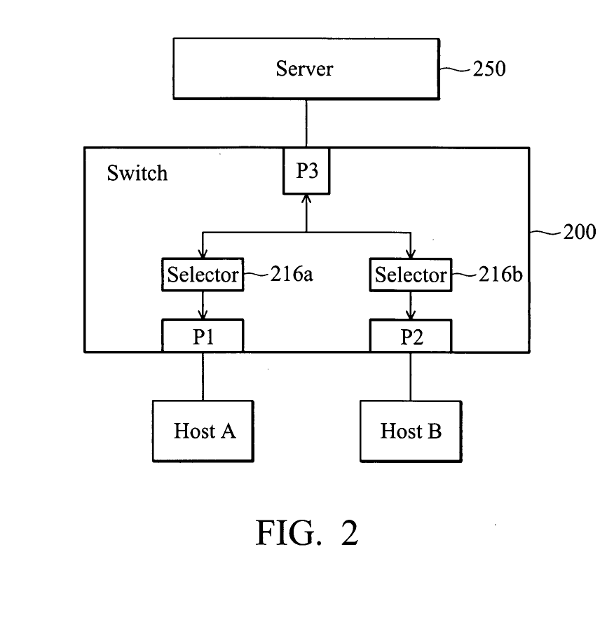

Several exemplary embodiments of the invention are described with reference to FIGS. 2 through 4, which generally relate to a packet transmission method applied in a VLAN. It is to be understood that the following disclosure provides many different embodiments as examples, for implementing different features of the invention. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

FIG. 2 is a schematic view of an embodiment of a packet transmission apparatus applied in a VLAN.

Packet transmission apparatus (switch) 200 comprises ports 1, 2, and 3 (P1, P2, and P3). P1 coupls to a selectro 216a and P2 couples to a selector 216b. Host A connects to switch 200 via P1, host B connects to switch 200 via P2, and server S connects to switch 200 via P3. Additionally, VLAN 1 members for switch 200 comprise P1 and P3, VLAN 2 for switch 200 members comprise P2 and P3, and VLAN 3 members for switch 200 comprise P1, P2, and P3.

As described, host A can only transmit and accept VLAN-tagged frames with VID=1 via P1 and host B can only transmit and accept VLAN-tagged frames with VID=2 via P2, while server 200 can transmit and accept any VLAN-tagged frame via P3. To resolve the drawback, the invention defines a lookup table to record VLAN members and a swap ID of both P1 and P2. The VLAN members are applied to determine whether a VLAN-tagged frame is transmitted from and to the same VLAN members, and, if so, it is then determined whether host A or host B can receive a transmitted VLAN-tagged frame with VID=N (N=1, 2, or 3 herein) via P1 or P2. If not, the VID of the transmitted VLAN-tagged frame is swapped with the swap VID of P1 or P2 for acceptance.

Server S, for example, transmits a VLAN-tagged frame with VID=3 to host A via P3. A lookup operation is executed to determine P1 and P3 are the same VLAN members and the frame is forwarded to P1. Since P1 can only receive a VLAN-tagged frame with VID=1, the VID of the transmitted frame must be swapped for 1 using selector 216a, thus, the VID changes from 3 to 1 and host A can receive the transmitted VLAN-tagged frame with VID=1 via P1.

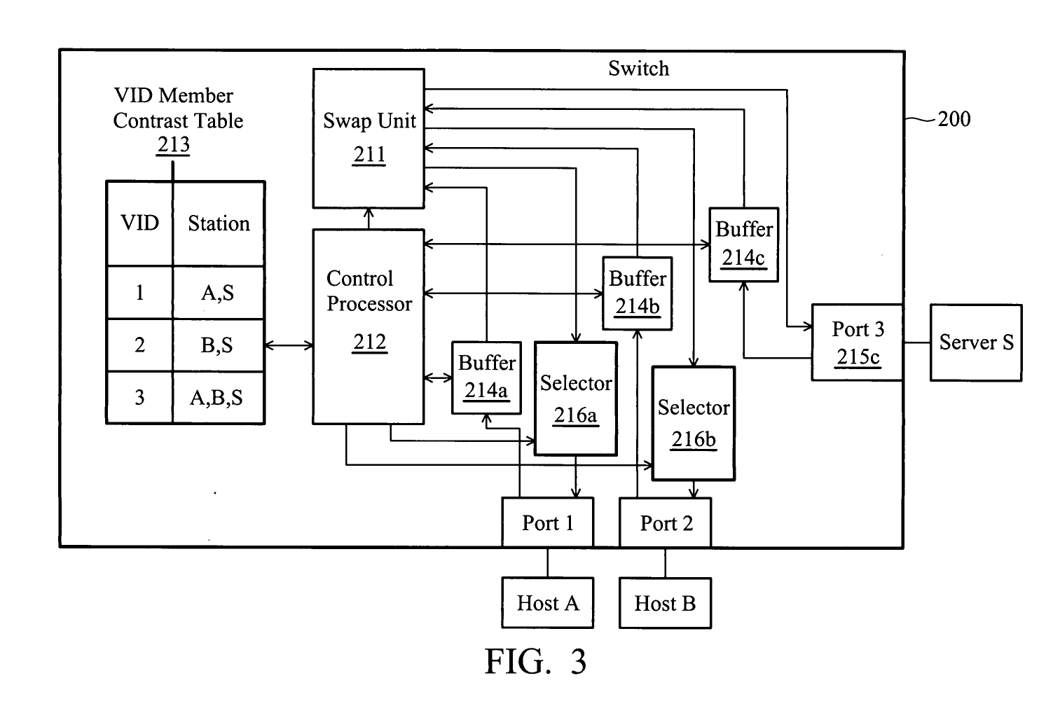

FIG. 3 is a schematic view of the architecture of switch 200 shown in FIG. 2. Switch unit 200 comprises a swap unit 211, a control processor 212, a VID member contrast table 213, a buffer 214a, a buffer 214b, a buffer 214c, a selector 216a, a selector 216b, and ports 1, 2, and 3 (P1, P2, and P3).

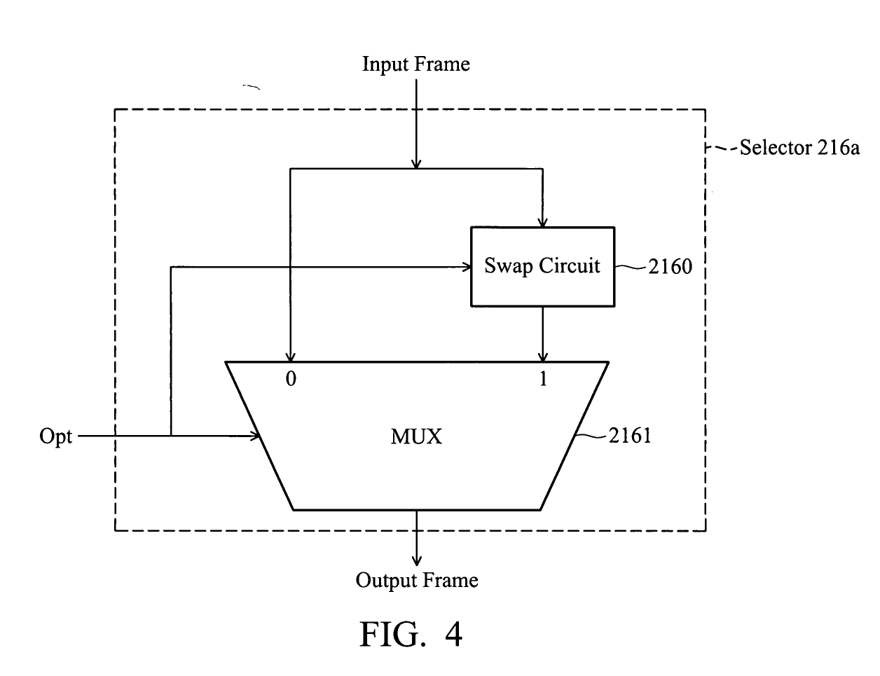

FIG. 4 is a schematic view of an embodiment of the architecture of selector 216a shown in FIG. 3. Selector 216a comprises a swap unit 2160 and a multiplexer (MUX) 300. selector 216b comprises the same components like that of selector 216a.

Referring to FIGS. 2 and 3, host A transmits and receives frames through port 1, host B transmits and receives frames through port 2, and server S transmits and receives frames through port 3. Port 1 stores frames sent by host A in buffer 214a. Port 2 stores frames sent by host B in buffer 214b. Port 3 stores frames sent by server S in buffer 214c. Buffer 214a checks VID member contrast table 213 via control processor 212 to determine a VLAN belonged thereto. Buffer 214b checks VID member contrast table 213 via control processor 212 to determine a VLAN belonged thereto. Buffer 214c checks VID member contrast table 213 via control processor 212 to determine a VLAN belonged thereto. When control processor 212 determines transmission destinations corresponding to frames stored in buffers 214a, 214b, and 214c, swap unit 211 forwards the stored frames to corresponding transmission destinations. Frames stored in buffer 214a, for example, are forwarded to port 3, indicating the transmission destination is port 3. Frames stored in buffer 214c are forwarded to selector 216b, indicating the transmission destination is selector 216b.

As described in FIG. 2, a swap operation for host A, for example, is implemented by selector 216a. Swap circuit 2160 further comprises a register (not shown) comprising 12 bits to store, for example, a swap VID for host A. Swap circuit 2160 determines whether an input frame with original 12 bits is transformed by a swap ID stored in the register (not shown) according to an optional identifier (Opt) with 1 bit. Further, MUX 300 determines whether the input frame or the transformed frame is received according to an optional signal (0 or 1) from the optional identifier to generated an output frame. If a transmission destination is port 3, a forwarded frame is directly output to server S. If a transmission destination is selector 216a, an original frame or a transformed frame is forwarded to port 1 and received by host A. If a transmission destination is selector 216b, an original frame or a transformed frame is forwarded to port 2 and received by host B. The swap method using the swapping device is only an example and is not intended to be limitative.

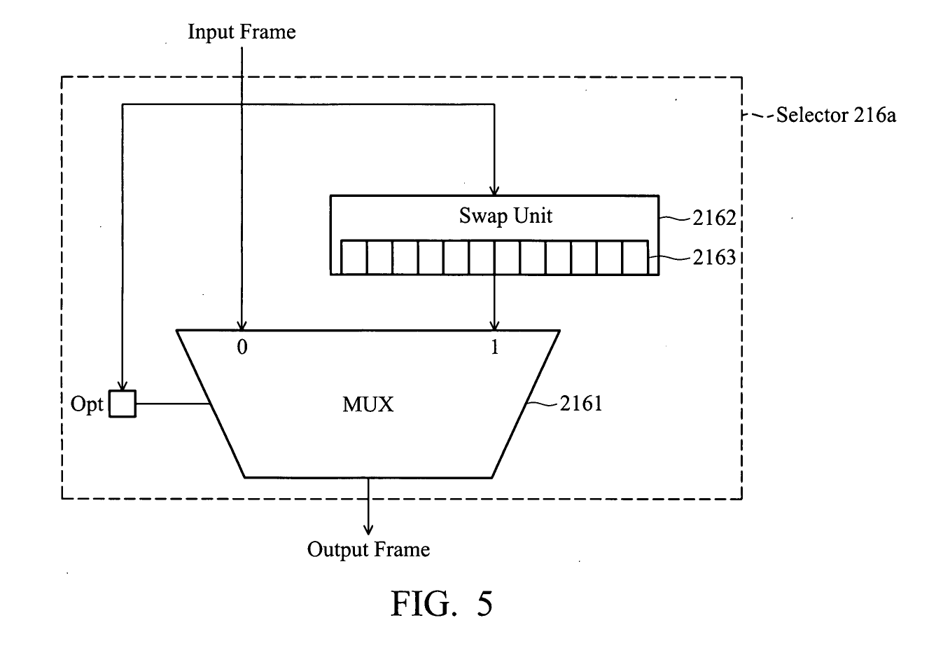

FIG. 5 is a schematic view of another embodiment of the architecture of selector 216a shown in FIG. 3.

Referring to FIGS. 2 and 3, a swap operation, for example, for host A is implemented by selector 216a comprising multiplexer 2161 coupling to a swap unit 2162 serving as swap circuit 2160. Swap unit 2162 further comprises a register 2163 to store, for example, a swap VID for host A. A frame may further comprise 1 bit of an optional identifier to determine whether the frame can be received by host A. As shown in FIG. 5, when an input frame is forwarded to host A, the VID thereof is transmitted to swap unit 2162 and swapped with a swap VID stored in register 2163. Further, multiplexer 2161 receives an optional signal (0 or 1) from the input frame for determination to output the frame directly or with a swap VID according to the optional bit. When server S transmits a VLAN-tagged frame with VID=1, the optional bit is set to 0, indicating multiplexer 2161 can transmit the frame to host A directly. Alternately, when server S transmits a VLAN-tagged frames with the value of the VID not equaling 1, the optional bit is set to 1, indicating host A may receive the frame with a swap VID from multiplexer 2161. The swap method using swap unit 2162 is only an example and is not intended to be limitative.

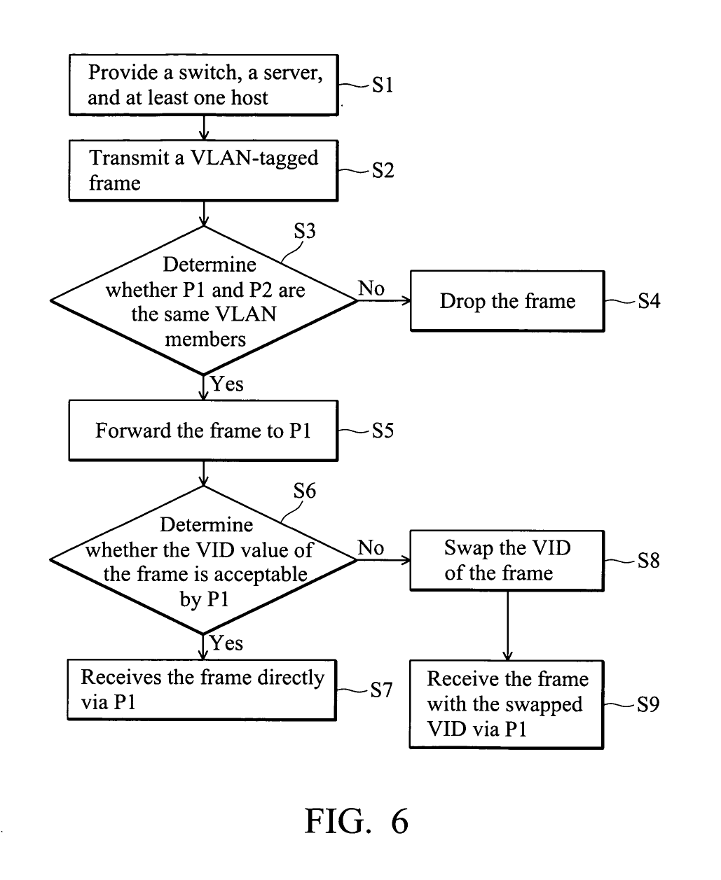

FIG. 6 is a flowchart of an embodiment of a packet transmission method applied in a VLAN.

A switch, a server, and at least one host are provided (step S1). The switch comprises at least first and second ports (P1 and P2). The server connects to the switch via 2 and the host connects to the switch via P1. With respect to the switch, P1 and P2 are grouped as the same VLAN members. The host can only receive a VLAN-tagged frames with VID=1. Next, the server transmits a VLAN-tagged frame with the value of VID is, or not, equal to 1 to the host via P2 (step S2). It is determine whether P1 and P2 are the same VLAN members according to a VID member contrast table (step S3). If not, the frame is dropped by P1 (step S4). If so, the frame is forwarded to P1 (step S5).

It is determined whether the frame can be received by the host (step S6), indicating it is determined whether the VID value of the frame is acceptable by P1. If so, the host receives the frame directly via P1 (step S7). If not, the VID value of the frame is swapped with an acceptable VID value (step S8), and the host receives the frame with the swapped VID via P1 (step S9).

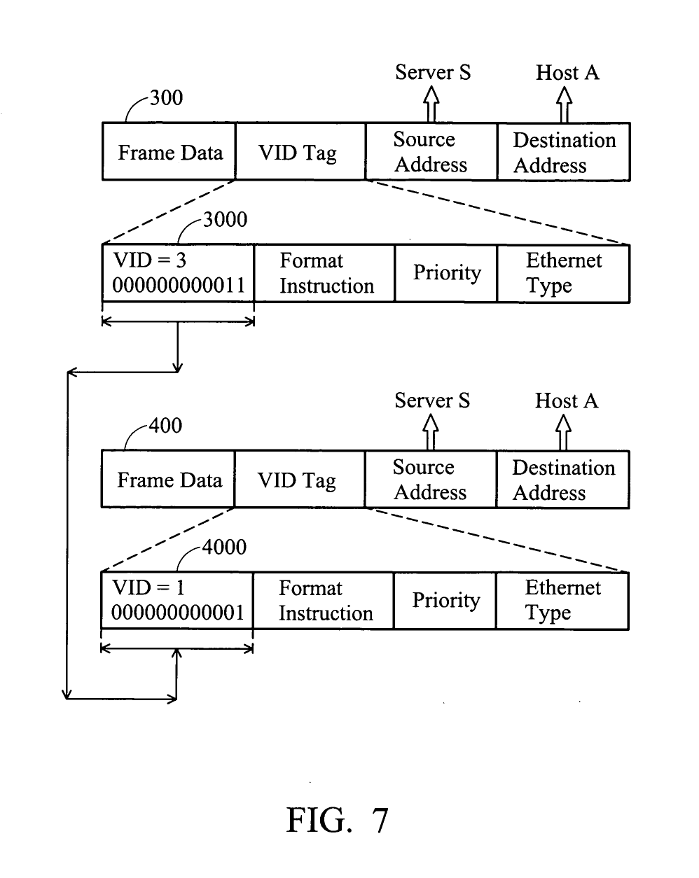

FIG. 7 is a schematic view of the architecture of a VLAN-tagged frame, in which a frame transformed with a swap VID is showed. VLAN-tagged frame 300 is an input frame sent by server S, in which VID of VID tag 3000 equals 3 (VID=3). VLAN-tagged frame 400 is a swapped frame with VID=1, which is transformed from the input frame. It is noted that field data of frame 300 is identical to that of frame 400 except for the VIDs.

A packet transmission method of the invention enables connections to multiple VLANS and a host to receive VLAN-tagged frames via a restricted port of a switch. Additionally, the swap method of the invention is implemented using a 4-bit VLAN tag added to a VLAN frame, which is compatible for network devices complying with IEEE 802.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A packet transmission apparatus, applied in a virtual local area network (VLAN), comprising:
a switch, comprising a first port, a second port, a selector coupling to the first port, a swap unit, a control processor, and a memory, wherein the memory stores a VID member contrast table;
a server, connecting to the switch via the second port, capable of transmitting a frame with a VID value via the second port;
a host, connecting to the switch via the first port, capable of receiving the frame from the server;
wherein the control processor determines whether the first port and the second port are the same group members according to the VID member contrast table, if so, the swap unit forwards the frame to the selector, the selector determines whether the VID value of the frame is acceptable and, if not, swaps the VID value of the frame with an acceptable VID value, and the host receives the frame with the swapped VID value via the first port.

2. The packet transmission apparatus as claimed in claim 1, further comprising a first buffer coupling to the first port and a second buffer coupling to the second port, wherein frames sent by the host is stored in the first buffer and frames sent by the server is stored in the second buffer.

3. The packet transmission apparatus as claimed in claim 1, wherein the host receives the frame directly via the first port if the VID value of the frame is acceptable before the swap operation is implemented.

4. The packet transmission apparatus as claimed in claim 1, wherein the control processor drops the frame if the first port and the second port are different group members

5. The packet transmission apparatus as claimed in claim 1, wherein the frame is a VLAN-tagged frame.

6. A packet transmission method, comprising:
providing a switch, a server, and at least one host, wherein the switch comprises at least one first port and one second port and the host connects to the switch via the first port and the server connects to the switch via the second port;
transmitting a frame with a VID value by the server to the host via the second port;
determining whether the first port and the second port are the same group members;
if so, forwarding the frame to the first port;
determining whether the VID value of the frame is acceptable by the first port;
if not, swapping the VID value of the frame with an acceptable VID value; and
receiving the frame with the swapped VID value bye the host via the first port.

7. The packet transmission method as claimed in claim 6, further comprising receiving the frame directly by the host via the first port if the VID value of the frame is acceptable before the swap operation is implemented.

8. The packet transmission method as claimed in claim 6, further comprising dropping the frame if the first port and the second port are different group members.

9. The packet transmission method as claimed in claim 6, further comprising defining a VID member contrast table to record port memberships for group member determination.

10. A packet transmission apparatus, applied in a virtual local area network, comprising:
a switch, comprising at least one first port and one second port;
a server, coupled to the switch, transmitting a frame with a VID value via the second port;
a host, coupled to the switch, receiving the frame from the server via the first port;
wherein the switch determines whether the first port and the second port are the same group members and, if so, forwards the frame to the first port, the first port determines whether the VID value of the frame is acceptable and, if not, swaps the VID value of the frame with an acceptable VID value, and the host receives the frame with the swapped VID value via the first port.

11. The packet transmission apparatus as claimed in claim 10, wherein the host receives the frame directly via the first port if the VID value of the frame is acceptable

12. The packet transmission apparatus as claimed in claim 10, wherein the host drops the frame if the first port and the second port are different group members

13. The packet transmission apparatus as claimed in claim 10, wherein the frame is a VLAN-tagged frame.
